(19) United States
(12) Patent Application Publication
(10) Pub. No.: US 2025/0361132 A1
(43) Pub. Date: Nov. 27, 2025

(54) BRIDGE CRANE CONSTRUCTION PLATFORM

(71) Applicant: Shanghai Zhenhua Heavy Industries Co., Ltd., Shanghai (CN)

(72) Inventors: Bao ZHOU, Shanghai (CN); Yuchun LU, Shanghai (CN); Cong JIA, Shanghai (CN); Zhiwen FENG, Shanghai (CN); Yunchen LI, Shanghai (CN)

(21) Appl. No.: 18/867,933

(22) PCT Filed: May 22, 2023
(86) PCT No.: PCT/CN2023/095545

§ 371 Date: Nov. 21, 2024

(30) Foreign Application Priority Data
May 23, 2022 (CN) 202221238383.2

(51) Int. Cl. B66F 11/04; B66C 13/54; E06C 9/02

(52) U.S. Cl. CPC B66F 11/04; B66C 13/54; E06C 9/02

(57) ABSTRACT

The utility model provides a bridge crane construction platform, including: a platform framework, which is configured to be connected to a translation trolley of a girder of a bridge crane: a fixing frame, wherein a first end of the fixing frame is fixedly connected to the platform framework: a rotating single-arm mechanism, which is arranged at a second end of the fixing frame and is rotatably connected to the fixing frame, and the second end facing away from the first end: a lifting hook mechanism, which is arranged on the rotating single-arm mechanism and is used for lifting materials. For the bridge crane construction platform of the utility model, the platform framework is arranged on a platform trolley of the bridge crane, so that the platform framework can rapidly translate along with the platform trolley, and the maneuverability of the bridge crane construction platform is effectively improved. In addition, the rotating single-arm structure, which can rotate, is provided on the fixing frame on the platform framework, so that the direction of the rotating single-arm structure can be adjusted according to the arrangement of components in the bridge crane. In this way, the applicability is effectively improved, and the extension construction of parts and components at a front end of a front girder of the bridge crane is implemented.

### TECHNICAL FIELD

The utility model relates to the field of equipment maintenance, and in particular to a bridge crane construction platform.

### BACKGROUND

With the development of the international shipping industry, the old single-box girder bridge cranes used in transport ships can no longer meet the needs of the dock. The modification of transport ships to increase height and width is a trend in the market, but the dock currently lacks a construction platform for increasing the height and length of the existing single-box girder bridge cranes.

### Contents of the Utility Model

In view of this, the utility model provides a bridge crane construction platform to solve the problem of the lack of a construction platform for modifying a bridge crane at the dock.

In order to solve the above technical problems, the utility model adopts the following technical solutions:

A bridge crane construction platform according to an embodiment of the utility model is provided, including:
a platform framework, where the platform framework is configured to be connected to a translation trolley of a girder of a bridge crane;
a fixing frame, where a first end of the fixing frame is fixedly connected to the platform framework;
a rotating single-arm mechanism, where the rotating single-arm is arranged at a second end of the fixing frame and is rotatably connected to the fixing frame, and the second end faces away from the first end; and
a lifting hook mechanism, where the lifting hook mechanism is arranged on the rotating single-arm mechanism and is used for lifting materials.

In an embodiment of the utility model, the platform framework includes:
a platform body, where the platform body is fixedly connected to the translation trolley; and
a plurality of diagonal bracing tubes, where one end of the plurality of diagonal bracing tubes is connected to the platform body, and the other end is connected to the translation trolley through an ear plate.

In an embodiment of the utility model, the fixing frame is formed as a tripod.

In an embodiment of the utility model, the rotating single-arm mechanism includes:
a single arm, where the single arm is rotatably connected to the second end of the fixing frame; and
a first stepper motor, where the first stepper motor is arranged on the fixing frame and is electrically connected to the single arm, and is configured to drive the single arm to rotate.

In an embodiment of the utility model, a pulley track is formed on the single arm, and the lifting hook mechanism is slidably connected to the single arm through the pulley track.

In an embodiment of the utility model, the lifting hook mechanism includes:
a lifting hook body, where the lifting hook body is slidably connected to the single arm through the pulley track; and
a second stepper motor, where the second stepper motor is arranged on the single arm and is electrically connected to the lifting hook body, and is configured to drive the lifting hook body to move along a length direction of the single arm through the pulley track.

In an embodiment of the utility model, the bridge crane construction platform further includes:
a controller, where the controller is electrically connected to the first stepper motor and the second stepper motor, respectively, and is configured to control the first stepper motor and the second stepper motor.

In an embodiment of the utility model, the bridge crane construction platform further includes:
a connecting frame, where the connecting frame is arranged on the platform framework and is parallel to the fixing frame, and a fixing plate is formed on the side of the connecting frame away from the platform framework, and the fixing plate is used to be detachably connected to the end of the single arm away from the fixing frame.

In an embodiment of the utility model, the connecting frame is formed as a tripod.

In an embodiment of the utility model, a maintenance ladder is provided on the connecting frame.

The above technical solution of the utility model has at least one of the following beneficial effects:
1. For the bridge crane construction platform of the utility model, the platform framework is connected to a platform trolley of the bridge crane, so that the bridge crane construction platform can rapidly translate along with the platform trolley. In this way, the maneuverability of the bridge crane construction platform is effectively improved.
2. For the bridge crane construction platform of the utility model, a rotating single-arm mechanism arranged on the fixing frame can rotate around the fixing frame, so that the direction of the rotating single-arm mechanism can be adjusted according to the arrangement of components of the bridge crane. In this way, the applicability is effectively improved, and the extension construction of parts and components at the front end of the front girder of the bridge crane is implemented.

### BRIEF DESCRIPTION OF DRAWINGS

FIG. 1 is a schematic structural diagram of a side view of a bridge crane construction platform according to an embodiment of the utility model;

FIG. 2 is a schematic structural diagram of a bridge crane construction platform with a rotating single-arm mechanism unfolded according to an embodiment of the utility model:

FIG. 3 is a schematic structural diagram of a front view of a bridge crane construction platform according to an embodiment of the utility model; and

FIG. 4 is a schematic structural diagram of assembly of a bridge crane construction platform according to an embodiment of the utility model.

Reference signs: 100, platform framework: 110, platform body: 120, diagonal bracing tube: 121, ear plate: 200, fixing frame: 310, single arm: 400, lifting hook mechanism: 410, lifting hook body: 420, second stepper motor: 500, connecting frame: 600, maintenance ladder: 700, bridge crane.

### DETAILED DESCRIPTION OF EMBODIMENTS

In order to make an objective, a technical solution, and advantages of the embodiments of the utility model clearer, the technical solutions of the utility model are clearly and completely described below with reference to the embodiments of the utility model. Obviously, the described embodiments are some, not all, embodiments of the utility model. All other embodiments obtained by the person skilled in the art based on the described embodiments of the utility model belong to the protection scope of the utility model.

Unless otherwise defined, the technical terms or scientific terms used in the utility model shall have the usual meanings understood by the person skilled in the art to which the utility model belongs. “First”, “second” and similar words used in the utility model do not indicate any order, quantity or importance, but are only used to distinguish different components. Likewise, words like “a” or “one” do not denote a limitation in quantity, but indicate that there is at least one. The words “connected” or “connection” and the like are not limited to physical or mechanical connections, but may include electrical connections, whether direct or indirect. “Up”, “down”, “left”, “right”, etc. are only used to indicate relative positional relationships. When the absolute position of the object being described changes, the relative positional relationship also changes accordingly.

The old-fashioned single-box girder bridge cranes used in transport ships can no longer meet the needs of the dock. The modification of transport ships to increase height and width is a trend in the market, but the dock currently lacks a construction platform for increasing the height and length of the existing single-box girder bridge cranes. To solve the above problem, the utility model provides a bridge crane construction platform.

A bridge crane construction platform according to the utility model is first described in detail with reference to the accompanying drawings.

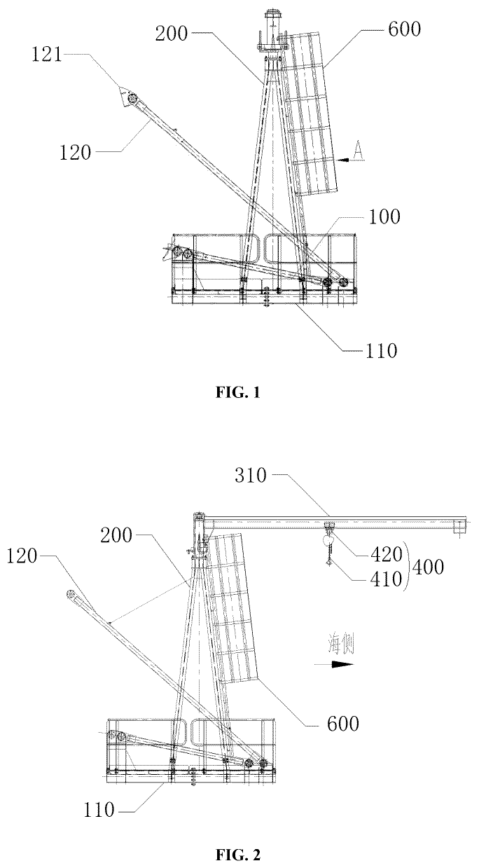

As shown in FIGS. 1, 2 and 4, the utility model provides a bridge crane construction platform, to solve the problem that the dock lacks a construction platform for modifying the bridge crane 700, and the bridge crane construction platform includes: a platform framework 100, a fixing frame 200, a rotating single-arm 310 mechanism, and a lifting hook mechanism 400. The platform framework 100 is configured to be connected to a translation trolley of a girder of the bridge crane 700. A first end of the fixing frame 200 is fixedly connected to the platform framework 100. The rotating single-arm 310 mechanism is arranged at a second end of the fixing frame 200 and is rotatably connected to the fixing frame 200, and the second end faces away from the first end. The lifting hook mechanism 400 is arranged on the rotating single-arm 310 mechanism, and is used for lifting materials.

Specifically, when an extension operation needs to be performed on a front girder of the single-box girder bridge crane 700, the platform framework 100 can be hoisted by a truck crane and adjusted by a hand chain hoist. After the adjustment is completed, the platform framework 100 is fixed to the platform trolley of the bridge crane 700. Then, the platform trolley can be operated to drive the platform framework 100 to translate to a front end of a front girder of the bridge crane 700. In this case, the rotating single-arm 310 mechanism on the fixing frame 200 is parallel to a length direction of the front girder of the bridge crane 700. After the platform framework 100 is translated into place, the rotating single-arm 310 mechanism can be operated to rotate to be perpendicular to the front girder of the bridge crane 700. Then, the construction personnel can board the platform framework 100 to perform the extension operation on the front girder, and can use the lifting hook mechanism 400 to transport the extension components. As a result, the components required for the extension of the front girder can be conveniently and quickly transported, and the extension operation on the front girder can be carried out, so that production efficiency is effectively improved.

As shown in FIGS. 1, 2 and 4, as in one embodiment of the utility model, the platform framework 100 includes: a platform body 110 and a plurality of diagonal bracing tubes 120. The platform body 110 is fixedly connected to the translation trolley. One end of the plurality of diagonal bracing tubes 120 is connected to the platform body 110, and the other end is connected to the translation trolley through an ear plate 121.

Specifically; the platform body 110 is arranged on the translation trolley, and can move along the length direction of the front girder of the bridge crane 700 with the translation trolley. As a result, the construction personnel can move to the end of the front girder through the translation trolley and perform the extension operation on the front girder, and the construction personnel can work above the platform, which is convenient and quick to operate, and effectively improves the construction safety. In addition, a plurality of diagonal bracing tubes 120 are provided on the platform framework 100, one end of the diagonal bracing tube 120 is rotatably connected to the platform body 110 by using a pin, and the other end is detachably connected to the translation trolley by using a clamping plate. In the initial state, the diagonal bracing tube 120 can be erected. When the extension operation needs to be performed on the front girder, the diagonal bracing tube 120 can be lowered, and the diagonal bracing tube 120 is connected to the translation trolley. Thus, the platform body 110 and the translation trolley are connected by the plurality of detachable diagonal bracing tubes 120, so that the connection strength of the platform body 110 and the translation trolley is effectively improved, and the structural strength and safety performance are effectively improved.

As shown in FIGS. 1, 2 and 4, in one embodiment of the utility model, the fixing frame 200 is formed as a tripod. Specifically, the fixing frame 200 is formed as a hollow tripod, the tripod is light in weight and stable in structure, and can stably bear the load. Thus, by using the fixing frame 200 formed as a tripod, the self-weight of the bridge crane construction platform is further reduced, and the stability of the bridge crane construction platform is effectively improved, so that the weight of the components lifted by the rotating single-arm 310 mechanism can be stably supported.

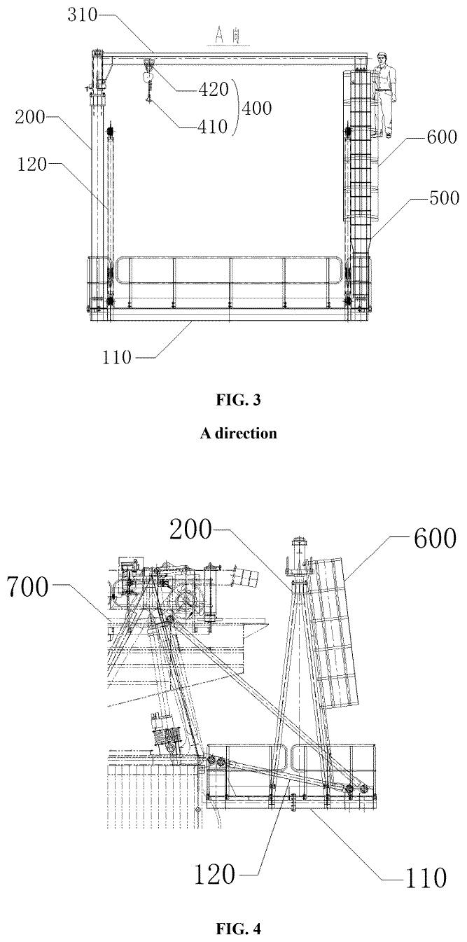

As shown in FIG. 3, in one embodiment of the utility model, the rotating single-arm 310 mechanism includes: a single arm 310 and a first stepper motor (not shown). The single arm 310 is rotatably connected to the second end of the fixing frame 200. The first stepper motor is arranged on the fixing frame 200 and is electrically connected to the single arm 310, and is configured to drive the single arm 310 to rotate. Specifically, the stepper motor has good control performance and fast start and stop, and can stably drive the single arm 310 to rotate. In the initial state, when the single arm 310 is in a parallel state with the front girder of the bridge crane 700, when the extension operation needs to be performed on the front girder, the platform framework 100 can be moved to the end of the front girder, and then the first stepper motor can be started to drive the single arm 310 to rotate, so that the single arm 310 is perpendicular to the length direction of the front girder. In this case, the single arm 310 is located directly above the platform body 110 of the platform framework 100, and the extension component of the front girder can be transported by the construction personnel by using the single arm 310. When the construction work is completed, the first stepper motor is started to drive the single arm 310 to rotate, so that the single arm 310 is parallel to the length direction of the front girder. Thus, the construction efficiency of the extension operation on the front girder is effectively improved.

In one embodiment of the utility model, a pulley track is formed on the single arm 310, and the lifting hook mechanism 400 is slidably connected to the single arm 310 through the pulley track. Specifically, the lifting hook mechanism 400 can move along the length direction of the single arm 310, so that the transportation distance for transporting the extension component is effectively improved. Thus, the construction efficiency of the extension operation on the front girder is further improved.

As shown in FIGS. 2 and 3, in one embodiment of the utility model, the lifting hook mechanism 400 includes: a lifting hook body 410 and a second stepper motor 420. The lifting hook body 410 is slidably connected to the single arm 310 through the pulley track. The second stepper motor 420 is arranged on the single arm 310 and is electrically connected to the lifting hook body 410, and is configured to drive the lifting hook body 410 to move along the length direction of the single arm 310 through the pulley track. Specifically, the stepper motor has good control performance and quick start and stop, and the second stepper motor 420 can stably drive the lifting hook body 410 to move stably along the length direction of the single arm 310, so that the construction efficiency is effectively improved.

In one embodiment of the utility model, the bridge crane construction platform further includes: a controller (not shown). The controller is electrically connected to the first stepper motor and the second stepper motor 420 respectively, and is used to control the first stepper motor and the second stepper motor 420. Specifically, when the first stepper motor and the second stepper motor 420 need to be controlled, the construction personnel can issue instructions through the wireless remote control, and the controller can control the first stepper motor and the second stepper motor 420 accordingly after receiving the instructions. As a result, the corresponding speed of the construction platform is effectively improved, and the construction efficiency is improved.

As shown in FIG. 3, in one embodiment of the present utility model, the bridge crane construction platform further includes: a connecting frame 500. The connecting frame 500 is arranged on the platform framework 100 and is parallel to the fixing frame 200. A fixing plate is formed on the side of the connecting frame 500 away from the platform framework 100, and the fixing plate is used to be detachably connected to the end of the single arm 310 away from the fixing frame 200. Specifically, when the platform framework 100 reaches the end of the front girder of the bridge crane 700, the single arm 310 can be controlled to rotate to a position perpendicular to the front girder. In this case, the single arm 310 contacts the fixing plate, and a pin can be arranged in the single arm 310 and the fixing plate in a penetration manner, to detachably connect the single arm 310 and the connecting frame 500. As a result, the structural strength of the bridge crane construction platform is improved, and the construction safety is effectively improved.

As shown in FIGS. 1 and 2, in one embodiment of the utility model, the connecting frame 500 is formed as a tripod. The connecting frame 500 is formed as a hollow tripod, and the tripod is light in weight and stable in structure, and can stably bear the load. Thus, by using the connecting frame 500 formed as a tripod, the self-weight of the bridge crane construction platform is further reduced, while the stability of the bridge crane construction platform is effectively improved, and the weight of the components lifted by the rotating single-arm 310 mechanism can be stably supported.

As shown in FIGS. 1 and 2, in one embodiment of the utility model, a maintenance ladder 600 is provided on the connecting frame 500. Specifically, the construction personnel can climb up to the end of the bridge crane construction platform through the maintenance ladder 600 to perform maintenance on the bridge crane construction platform. Thus, the reliability of the bridge crane construction platform is effectively improved.

For the bridge crane construction platform of the utility model, the platform framework 100 is connected to the platform trolley on the bridge crane 700, so that the bridge crane construction platform can be translated together with the platform trolley. In this way, the maneuverability of the bridge crane construction platform is effectively improved. At the same time, the rotating single-arm 310 mechanism arranged on the fixing frame 200 can rotate around the fixing frame 200, so that the direction of the rotating single-arm 310 mechanism can be adjusted according to the arrangement of the components of the bridge crane 700. In this way, the applicability is effectively improved, and the extension construction of the parts and components at the front end of the front girder of the bridge crane 700 is implemented.

The above description is the preferred embodiment of the utility model. It should be noted that for the person skilled in the art, various improvements and modifications can be made without departing from the principles disclosed in the utility model, and these improvements and modifications should also be considered within the scope of protection of the utility model.

1. A bridge crane construction platform, comprising:
a platform framework, wherein the platform framework is configured to be connected to a translation trolley of a girder of a bridge crane;
a fixing frame, wherein a first end of the fixing frame is fixedly connected to the platform framework;
a rotating single-arm mechanism, wherein the rotating single-arm is arranged at a second end of the fixing frame and is rotatably connected to the fixing frame, and the second end faces away from the first end; and
a lifting hook mechanism, wherein the lifting hook mechanism is arranged on the rotating single-arm mechanism and is used for lifting materials.

2. The bridge crane construction platform according to claim 1, wherein the platform framework comprises:
a platform body, wherein the platform body is fixedly connected to the translation trolley; and
a plurality of diagonal bracing tubes, wherein one end of the plurality of diagonal bracing tubes is connected to the platform body, and the other end is connected to the translation trolley through an ear plate.

3. The bridge crane construction platform according to claim 1, wherein the fixing frame is formed as a tripod.

4. The bridge crane construction platform according to claim 1, wherein the rotating single-arm mechanism comprises:
a single arm, wherein the single arm is rotatably connected to the second end of the fixing frame; and
a first stepper motor, wherein the first stepper motor is arranged on the fixing frame and is electrically connected to the single arm, and is configured to drive the single arm to rotate.

5. The bridge crane construction platform according to claim 4, wherein a pulley track is formed on the single arm, and the lifting hook mechanism is slidably connected to the single arm through the pulley track.

6. The bridge crane construction platform according to claim 5, wherein the lifting hook mechanism comprises:
a lifting hook body, wherein the lifting hook body is slidably connected to the single arm through the pulley track; and
a second stepper motor, wherein the second stepper motor is arranged on the single arm and is electrically connected to the lifting hook body, and is configured to drive the lifting hook body to move along a length direction of the single arm through the pulley track.

7. The bridge crane construction platform according to claim 6, further comprising:
a controller, wherein the controller is electrically connected to the first stepper motor and the second stepper motor, respectively, and is configured to control the first stepper motor and the second stepper motor.

8. The bridge crane construction platform according to claim 4, further comprising:
a connecting frame, wherein the connecting frame is arranged on the platform framework and is parallel to the fixing frame, a fixing plate is formed on the side of the connecting frame away from the platform framework, and the fixing plate is used to be detachably connected to the end of the single arm away from the fixing frame.

9. The bridge crane construction platform according to claim 8, wherein the connecting frame is formed as a tripod.

10. The bridge crane construction platform according to claim 9, wherein a maintenance ladder is provided on the connecting frame.
